(19) United States
(12) Patent Application Publication
(10) Pub. No.: US 2024/0116050 A1
(43) Pub. Date: Apr. 11, 2024

(54) MICROFLUIDIC BUBBLE TRAP

(71) Applicant: GENOBIO, INC., Seoul (KR)

(72) Inventor: Ju Hyun HWANG, Seoul (KR)

(21) Appl. No.: 17/928,490

(22) PCT Filed: Oct. 17, 2022
(86) PCT No.: PCT/KR2022/015683

§ 371 Date: Nov. 29, 2022

(30) Foreign Application Priority Data
Oct. 18, 2021 (KR) 10-2021-0138207

(51) Int. Cl. B01L 3/00

(52) U.S. Cl. CPC B01L 3/502723; B01L 2200/0684; B01L 2300/0663; B01L 2300/0681; B01L 2300/0832; B01L 2400/0655

(57) ABSTRACT

The present disclosure relates to a microfluidic bubble trap for blocking or removing bubbles introduced inside a chip in the process of sensing, a separation, a measurement, an incubation, and an analysis based on the microfluidic technology and preventing a flow of fluid in a channel from being hindered or preventing bubbles from occupying the fluid, so that the functional efficiency in an operation such as a sample analysis, a sample separation, a measurement, and the like may be significantly improved.

The present disclosure provides a microfluidic bubble trap including a trap body for separating bubbles and the microfluid is introduced therethrough; a microfluid inlet connected in a first direction of the trap body and supplying the microfluid; and a microfluid outlet installed through an upper portion of the trap body and an end of a channel is disposed in a lower portion of the microfluid inlet.

### TECHNICAL FIELD

The present disclosure relates to a microfluidic bubble trap, and more specifically, to a microfluidic bubble trap for blocking or removing bubbles introduced inside a chip in the process of sensing, a separation, a measurement, an incubation, and an analysis based on the microfluidic technology, and preventing a flow of fluid in a channel from being hindered or preventing bubbles from occupying the fluid, so that the functional efficiency in an operation such as a sample analysis, a sample separation, a measurement, and the like can be significantly improved.

### BACKGROUND ART

Recently, although early diagnosis of cancer has been increased and a progress of therapy such as a targeted therapy has been developed, the cancer is still a major cause of death, and most cancers are cured completely through a surgical removal. However, it has been confirmed that a local relapse and a metastasis of cancer occur owing to the involvement of many factors even after a primary tumor is removed. Accordingly, one of the most crucial factors that discriminate a cancer treatment result and a prognosis is to determine a presence of cancer cells metastasized in the first diagnosis or a treatment period.

The metastasis of cancer cells to lymphatic gland or bone marrow is defined as a disseminated tumor cell (DTC), and the cancer cells circulating in peripheral blood of a cancer patient is defined as a circulating tumor cell (CTC). The cancer cells are cells left out of a primary lesion or a metastatic lesion.

The circulating tumor cell (CTC) has been expected as potent biomarkers for cancer diagnosis, analysis of therapeutic prognosis, and analysis of micro metastasis. In addition, the circulating cancer cell analysis has an advantage of being a non-invasive method in comparison with the conventional cancer diagnosis method, and thus is very promising as a future cancer diagnosis method. However, since a rate of cancer cells distributed in blood is exceptionally low such as, for example, one cancer cell per total billion normal cells or one cancer cell per million to ten million leukocytes in blood, the accurate analysis is very difficult, and accordingly, an accurate analysis method is required.

The technique of separating cells using a cell surface molecule marker plays especially significant role in bio science, pharmacy, and medical science. Particularly, the technique of separating cells using magnetism enables large amounts of target cells to be separated and has been applied to various ranges from a protein separation to a cell based therapy.

Recently, a technique has been used, in which a ferromagnetic particle bound with a probe such as a single antibody that peculiarly recognizes a surface marker of a target cell is labeled to a cell and separated therefrom. In this regard, a probe combined with a target biomolecule on a surface and magnetic particles are introduced into a sample solution to capture the target biomolecule, and the magnetic particles are separated from the sample solution, and accordingly, the target biomolecule is extracted. The method of separating a target biomolecule using magnetic beads has been already commercialized and widely used to separate cells, protein, nucleic acid, and other biomolecules. The magnetophoretic separation technique that separates magnetic particles by using a high gradient magnetic separation (HGMS) has advantages of having high efficiency and easy to use, the biological specificity is maintained by a biofriendly connection between the magnetic particles and the biological analysis material, and further, magnetic field is not influenced by a buffer solution or a sample in a device.

As a diagnosing method using the magnetophoresis related technique, a chip type diagnosing device based on the microfluidic technique has been used. The microfluid chip is provided with various channels in the chip to perform the magnetophoretic technique in a small space, and has advantages that a diagnosis is enabled in a site, and the diagnosis and identification of a constant level is possible without an equipment of complex laboratory level.

However, the various devices for the process of sensing, a separation, a measurement, an incubation, and an analysis based on the microfluidic technology have a problem that fine bubbles, which is essentially generated, are introduced into a channel. The fine bubbles block the channel and hinder a flow of the fluid or cause a flow rate change and a volume change in the channel, which deteriorates the efficiency of the function such as a separation, an analysis, a measurement, and the like (see FIG. 7).

A separate equipment is additionally required to remove the fine bubbles present in a sample or a buffer solution, and there is a disadvantage that the fine bubbles present in the sample or present in the solution such as the buffer solution may not be removed perfectly.

The conventional device for removing bubbles mainly uses the scheme in which an edge is formed in a fluid channel, and bubbles generated in the edge is coupled to the edge and separated therefrom. In addition to such a passive method, an active method of removing bubbles using a laser or electric field has been also used. However, the passive method using the edge has a disadvantage that when a certain number of bubbles is attached, a channel is full of bubbles, and the channel is closed. Furthermore, the fine bubbles are not attached to the edge and float around the fluid, and the removing efficiency for the fine bubble is degraded. In addition, the active method has high removing efficiency for the fine bubbles, but an additional equipment is required, and accordingly, the use is limited.

Accordingly, a new device for removing bubbles in a fluid is required, which may minimize the separate energy supply while removing efficiently bubbles generated in a fluid.

### DISCLOSURE

### Technical Problem

The present disclosure has been made to solve the problems of the prior art, and one object of the present disclosure is to provide a microfluidic bubble trap for blocking or removing bubbles introduced inside of a chip in the process of sensing, a separation, a measurement, an incubation, and an analysis based on the microfluidic technology and preventing a flow of fluid in a channel from being hindered or preventing bubbles from occupying the fluid, and accordingly, the functional efficiency in an operation such as a sample analysis, a sample separation, a measurement, and the like may be significantly improved.

### Technical Solution

To solve the problem described above, the present invention may provide a microfluidic bubble trap including: a trap body into which the microfluid is introduced and which separates bubbles; a microfluid inlet connected the trap body from a side direction thereof and supplying the microfluid; and a microfluid outlet installed passing through an upper portion of the trap body and having a channel, an end of which is disposed at a lower portion of the microfluid inlet.

In one embodiment, an internal portion of the trap body may be formed in a circular shape, a triangular shape, a rectangular shape, a pentagonal shape, or an octagonal shape.

In one embodiment, an end of a channel of the microfluid inlet may be extended to a position that crosses a center of the trap body and disposed therein.

In one embodiment, the present invention may provide a microfluidic bubble trap including: a trap body of which into a cylindrical internal portion the microfluid is introduced and which separate bubbles; a microfluid inlet connected the trap body from a side direction thereof and supplying the microfluid; and a microfluid outlet installed passing through an upper portion of the trap body and having a channel, an end of which is disposed at a lower portion of the microfluid inlet, wherein a diameter of the upper portion of the inside of the trap body is greater than a diameter of the lower portion thereof.

In one embodiment, the microfluid inlet may provide the microfluid in a tangential direction of the trap body having a cylindrical shape.

In one embodiment, the upper edge formed by an inner side of the upper portion of the trap body and a side surface inner wall of the trap body may have an edge shape which is connected along the circumference of the side surface inner wall.

In one embodiment, the upper edge that formed by an inner side of the upper portion of the trap body and the side surface inner wall of the trap body may have an angle of 70° to 120° based on the inner side surface of the upper portion.

In one embodiment, the present invention may provide a microfluidic bubble trap including: a trap body into which the microfluid is introduced and which separates bubbles; a microfluid inlet connected the trap body from a side direction thereof and supplying the microfluid; and a microfluid outlet installed passing through an upper portion of the trap body and having a channel, an end of which is disposed at a lower portion of the microfluid inlet, wherein the channel of the microfluid outlet has a micro structure formed on a surface thereof.

In one embodiment, the micro structure may be formed in a cylindrical shape, a triangular prism shape, a rectangular prism shape, a pentagonal column shape, a hexagonal column shape, or an octagonal column shape having a height of 50 μm to 100 μm and a diameter of 50 μm to 100 μm, and an interval between the micro structures is 50 μm to 200 μm.

In one embodiment, the micro structure may have hydrophile property when the microfluid has hydrophobic property, or has hydrophobic property when the microfluid has hydrophile property.

In one embodiment, the upper edge formed by the inside of the upper portion of the trap body and the side surface inner wall of the trap body may have the edge shape which is connected along a circumference of the side surface of the inner wall.

In one embodiment, the upper edge formed by the inside of the upper portion of the trap body and the side surface inner wall of the trap body may have an angle of 70° to 120° based on the inner side surface of the upper portion.

In one embodiment, the present invention may provide a microfluidic based diagnostic system including the microfluidic bubble trap.

In one embodiment, the present invention may provide the microfluidic based diagnostic system including: a fluid supplying portion for supplying a buffer solution or a microfluid; a microfluidic bubble trap for removing bubbles included in the fluid supplied from the fluid supplying portion; a lab-on-a-chip for mixing and separating the fluid passing through the microfluidic bubble trap; and a diagnosing means for analyzing the microfluid passing through the lab-on-a-chip.

In one embodiment, the lab-on-a-chip may include: a channel portion in which a fluid including a sample containing a magnetic particle and a buffer solution is accommodated and moved therethrough, and having an inlet through which the fluid is introduced and an outlet through which the magnetic particle and the buffer solution separated from the sample are discharged; and a turbulence forming portion for producing a turbulent flow inside the channel that is not in contact with the wire, which is disposed on an outer surface of the channel portion, generates a magnetic gradient to separate the magnetic particle, and includes one or more wires one end of which is parallel with a flow direction of the fluid.

### Advantageous Effects

The microfluidic bubble trap may block or remove bubbles introduced inside of a chip in the process of sensing, a separation, a measurement, an incubation, and an analysis based on the microfluidic technology and prevent a flow of fluid in a channel from being hindered or prevent bubbles from occupying the fluid, and accordingly, the functional efficiency in an operation such as a sample analysis, a sample separation, a measurement, and the like may be significantly improved.

### DESCRIPTION OF DRAWINGS

FIG. 1 schematically illustrates a structure of a microfluidic bubble trap according to an embodiment of the present disclosure.

FIG. 2 schematically illustrates a structure of a microfluidic bubble trap having a stepped portion according to an embodiment of the present disclosure.

FIG. 3 schematically illustrates a structure of a microfluidic bubble trap having an inside formed in a cyclone shape according to an embodiment of the present disclosure.

FIG. 4 schematically illustrates a structure of a microfluidic bubble trap having an inside formed in a cyclone shape according to an embodiment of the present disclosure.

FIG. 5 schematically illustrates a micro structure on a channel surface of a microfluid outlet according to an embodiment of the present disclosure.

FIG. 6 schematically illustrates an attachment of a fine bubble to a micro structure according to an embodiment of the present disclosure.

FIG. 7 illustrates a feature of bubble introduction according to the conventional microfluid chip, (a) shows bubbles generated in a channel, and (b) shows bubbles introduced in a channel.

FIG. 8 is a photograph of an installation of a microfluidic bubble trap according to an embodiment of the present disclosure.

FIG. 9 illustrates a diagnostic system including a microfluidic bubble trap according to an embodiment of the present disclosure, (a) shows a photograph of a feature before bubbles are introduced, and (b) shows a photograph of a feature of bubbles trapped in a bubble trap after the bubbles are introduced.

FIG. 10 schematically illustrates a diagnostic system according to an embodiment of the present disclosure.

FIG. 11 illustrations a schematic diagram of a lab-on-a-chip according to an embodiment of the present disclosure.

FIG. 12 illustrations a wire arrangement of a lab-on-a-chip according to an embodiment of the present disclosure.

FIG. 13 illustrations a wire arrangement of a lab-on-a-chip according to an embodiment of the present disclosure.

FIGS. 14 and 15 schematically illustrate a feature of a bubble trap whose an inside shape is modified according to an embodiment of the present disclosure.

FIG. 16 illustrations a shape of microfluid inlet and outlet according to an embodiment of the present disclosure.

### BEST MODE

Preferred embodiments of the present disclosure will now be described in detail. In the description of the present disclosure, detailed explanations of related art are omitted when it is deemed that they may unnecessarily obscure the essence of the present disclosure. Throughout the specification, when a certain portion “comprises” or “includes” a certain component, this indicates that the other components are not excluded and may be further included, unless the context specifically requires otherwise.

As the present disclosure allows for various changes and numerous embodiments, particular embodiments will be illustrated in drawings and described in detail in the written description. However, this is not intended to limit the present disclosure to particular embodiments, and it is to be appreciated that all changes, equivalents, and substitutes that do not depart from the spirit and technical scope of the present disclosure are encompassed in the present disclosure.

The present disclosure is not limited to the illustrated embodiments and may be embodied in various forms. Rather, the disclosed embodiments are provided so that this disclosure will be thorough and complete, and will fully convey the scope of the disclosure to those skilled in the art. In the drawings, the dimensions, such as widths and thicknesses, of elements may be exaggerated for clarity. The drawings are explained from an observer's point of view. It will be understood that when an element is referred to as being “on” another element, it can be directly on the other element, or one or more intervening elements may also be present therebetween. It will be understood by those skilled in the art that various changes in form and details may be made therein without departing from the spirit and scope of the disclosure as defined by the appended claims. The same reference numerals represent substantially the same elements throughout the drawings.

The terms used herein are merely used to describe particular embodiments and are not intended to limit the present disclosure. As used herein, the singular forms are intended to include the plural forms as well, unless the context clearly indicates otherwise. In the present disclosure, it is to be understood that the terms such as “including” or “having” are intended to indicate the existence of the features, numbers, steps, operations, actions, components, parts, or combinations thereof disclosed in the specification, and are not intended to preclude the possibility that one or more other features, numbers, steps, operations, actions, components, parts, or combinations thereof may exist or may be added.

On the other hand, terms used herein are to be understood as described below. While such terms as “first” or “second”, may be used to describe various elements, such elements must not be limited to the above terms. The above terms are used only to distinguish one element from another. For example, a first element may be referred to as a second element, and likewise a second element may be referred to as a first element.

As used herein, the singular forms are intended to include the plural forms as well, unless the context clearly indicates otherwise. In the present disclosure, it is to be understood that the terms such as “including” or “having” are intended to indicate the existence of the features, numbers, steps, operations, actions, components, parts, or combinations thereof disclosed in the specification, and are not intended to preclude the possibility that one or more other features, numbers, steps, operations, actions, components, parts, or combinations thereof may exist or may be added. Respective steps of the methods described herein may be performed in a different order than that which is explicitly described. In other words, the respective steps may be performed in the same order as described, substantially simultaneously, or in a reverse order.

As used herein, the term “and/or” encompasses both combinations of the plurality of related items disclosed and any item from among the plurality of related items disclosed. In the present specification, the description “A or B” means “A”, “B”, or “A and B.”

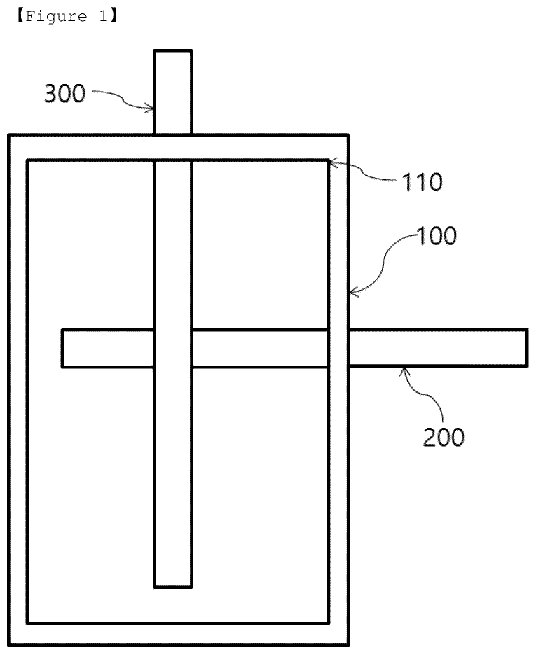

FIG. 1 schematically illustrates a structure of a microfluidic bubble trap according to the present disclosure, and FIG. 8 illustrates the actual installation feature.

The present disclosure relates to a microfluidic bubble trap comprising: a trap body into which the microfluid is introduced and which separates bubbles; a microfluid inlet connected the trap body from a side direction thereof and supplying the microfluid; and a microfluid outlet installed passing through an upper portion of the trap body and having a channel, and end of which is disposed at a lower portion of the microfluid inlet.

The trap body 100 is a portion of forming a space in which the microfluid is accommodated wherein an inside thereof may be formed in a circular shape, a triangular shape, a rectangular shape, a pentagonal shape, or an octagonal shape.

The bubbles mixed in the microfluid are condensed at an edge portion, and according to the conventional fine bubble trap, the bubbles are removed by using a plurality of edges. However, according to the present disclosure, the bubbles contained in the microfluid may be removed preferably through the upper portion of the body, and thus it is preferable that an inside of the body is formed in a circular shape, a triangular shape, a rectangular shape, a pentagonal shape, or an octagonal shape such that fine bubbles are not condensed in a wall surface.

In this case, a height of the body may be 5 to 20 mm, and an inner diameter of the body may be 3 to 5 mm. If the body has a size below the range, the removing effect of bubbles may be decreased, and if the body has a size above the range, the amount of a necessary sample and a buffer solution becomes greater, and uneconomic.

However, the portion at which a side surface of the inside and the inner surface of the upper surface meet is manufactured to form the edge 110, and the bubbles introduced with the microfluid simultaneously may be collected at the upper portion.

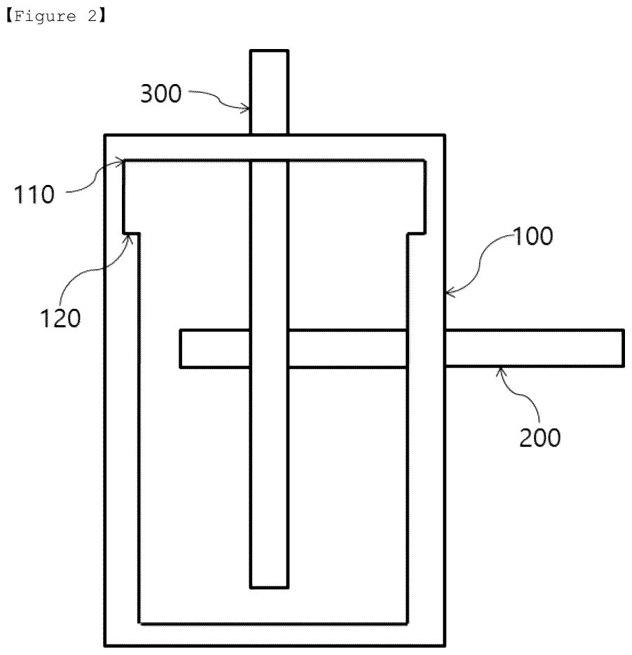

Furthermore, a stepped portion 120 is formed at an upper end of the body 100, and the bubbles may be located at the upper portion. As described above, the bubbles have the property of being collected near to the edge 120. According to the present disclosure, the edge 120 is formed at the portion at which a side surface of the inside and the inner surface of the upper surface meet, and the bubbles may be located at the upper portion of the body 100. However, to assist this, the stepped portion 120 may be formed preferably at the upper end of the body 100 (see FIG. 2). The stepped portion 120 is provided with an upper portion and a lower portion of which diameters are different and forms the edge. According to the present disclosure, the upper portion of the stepped portion 120 has a greater diameter than that of the lower portion of the stepped portion such that the bubbles are located at the upper portion of the body.

The bubbles located at the upper portion through the stepped portion 120 may be located only at the upper portion such that the bubbles do not move to the lower portion by the movement of the microfluid.

In this case, a difference of diameters between the upper portion and the lower portion may be 0.5 to 3 mm. If the difference of diameters is less than 0.5 mm, the effect owing to the stepped portion is not expected, and if the difference of diameters exceeds 3 mm, the bobbles are stalled at the stepped portion, and the discharge of the bubbles may not be smooth.

At the side surface of the body 100, the microfluid inlet 200 may be installed. The microfluid inlet 200 is a portion which supplies the microfluid into the inside of the body 100, and of which an end of a channel is extended and disposed wherein it may be extended to the position that crosses a center of the trap body. Since the inlet is installed at the side surface, the microfluid may be introduced and diffused therethrough. As the pressure decreases, a size of the bubbles included in the microfluid increases, and the cohesion and removal may become easier.

To further accelerate the cohesion of bubbles as such, the channel of the inlet may be extended and installed to the position that crosses the center (see FIG. 1). Through this, the supplied microfluid may collide strongly with a wall surface of the body when the microfluid is injected to the body 100, and owing to the collision, the cohesion of the bubbles included in the microfluid may be accelerated.

In describing this in more detail, the microfluid supplied through the extended channel becomes faster and the pressure thereof becomes decreased while the microfluid is discharged (Bernoulli's principle). In this case, the bubble included in the microfluid may be expanded as the pressure decreases, and accordingly, the size of the bubble becomes greater and the bubble is changed to ease the cohesion. Furthermore, since the channel is extended and installed to the position that crosses the center, the microfluid of which speed is increased may strongly collide with another side inner surface of the body. Through this, the bubble of which size is enlarged may be cohered and moved to the upper portion of the inner surface of the body owing to specific gravity, and then, discharged.

The microfluid outlet 300 may be installed passing through the upper portion of the trap body 100, and has a channel, an end of which may be disposed at the lower portion of the microfluid inlet 200. Since the outlet 300 needs to selectively discharge only the microfluid having great specific gravity, it is preferable that the outlet is installed at the lower portion of the trap body 100. However, if the outlet is installed simply by boring a bottom portion of the trap body, since the outlet inhales and discharges the fluid at the upper portion of the outlet, the fine bubble contained inside the trap body may be mixed and discharged with the microfluid. Furthermore, it is preferable that the bubble is removed while the microfluid supplied from the inlet is remaining in the trap body 100 for a certain time, however, if the outlet is formed at the bottom portion as described above, the fluid supplied from the inlet is not remaining but is discharged directly, and the fine bubble may be included in the discharged microfluid. Accordingly, it is preferable that the outlet 300 is installed passing through the upper center portion of the trap body 100, and the channel is extended and installed therefrom wherein the end of the channel is located at the lower portion of the microfluid inlet (see FIG. 1). Through this, it is possible to selectively discharge only the fluid located at the lower portion of the outlet, thereby minimizing the discharge of the mixture of the fine bubble. Particularly, the fluid supplied from the inlet 200 is remaining for a certain time, and then moves to the lower portion, thereby securing the remaining time of the microfluid and thus maximizing the separation between the microfluid and the bubble.

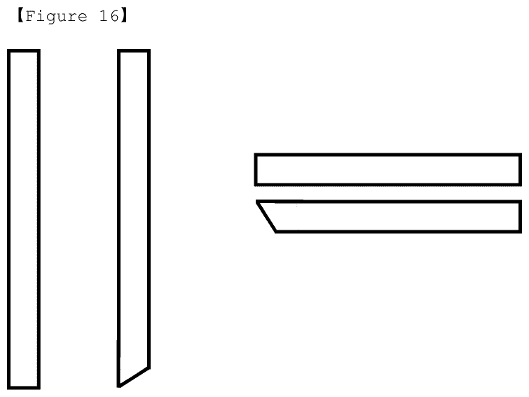

The ends of the microfluid inlet and the microfluid outlet may be cut obliquely for the efficiency of injection and discharge. If the ends are cut vertically, injection and discharge may be performed at an accurate position, but due to the high resistance, the speed of injection and discharge may be reduced. Accordingly, the resistance may be reduced by enlarging the size of the inlet and outlet. Because of this, the inlet and the outlet may be manufactured in the shape of cut obliquely (see FIG. 16).

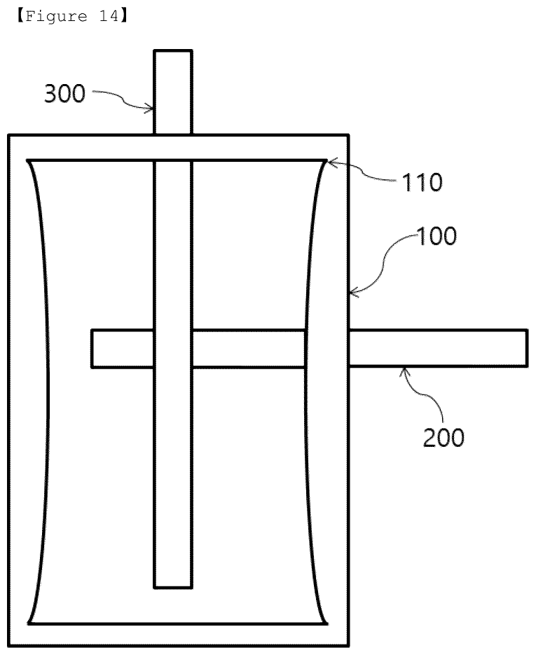

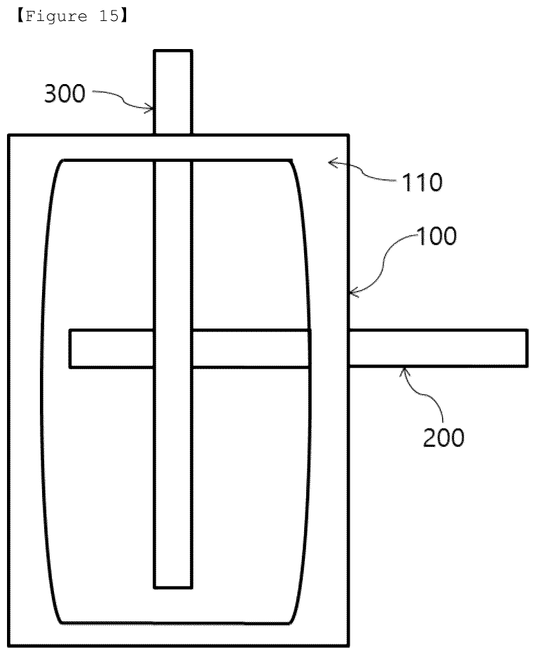

The inside of the trap body 100 may be formed in various shapes to discharge the bubble included in the microfluid. For this, a diameter of the center portion may be formed to be greater or smaller than diameters of the upper portion and the lower portion, and the cohesion efficiency of the bubble may be improved (see FIG. 14 and FIG. 15).

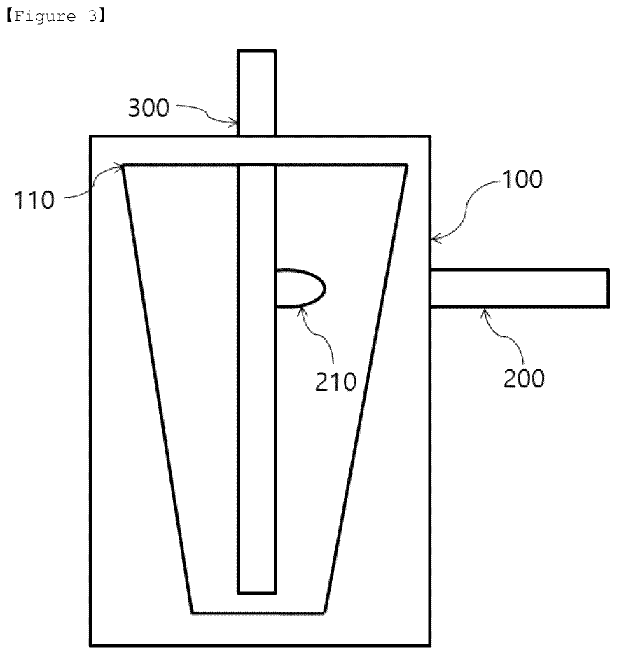

Specifically, the diameter of the upper portion of the inside of the trap body is greater than the diameter of the lower portion, which forms the inside as a type of cyclone, and the cohesion efficiency of the bubble may be maximized (see FIG. 3).

Since a gas is included in the bubble, the specific gravity of the bubble is lower than that of the microfluid. Accordingly, in the case that the centrifugal force is applied to the microfluid, it is possible to cohere the bubble and the fluid due to the specific gravity.

For this, the diameter of the lower portion of the inside of the trap body may be smaller than the diameter of the upper portion, and accordingly, the microfluid supplied to the inside of the trap body 100 rotates in one direction, and the bubble may be separated by the centrifugal force.

In addition, to provide the rotational force to the microfluid supplied to the inside of the body, the microfluid inlet 200 may supply the microfluid in a tangential direction of the trap body of cylindrical shape (210). Through this, the microfluid supplied in the trap body may be descend by the gravitational force while rotating in one direction, and the bubble included in the microfluid may be collected at the center portion of the trap body 100 and may be ascend due to the specific gravity difference (see FIG. 2).

Particularly, in the present disclosure, the channel of the microfluid outlet 300 is extended and installed at the center of the trap body 100 such that the bubble may be cohered near to the channel of the microfluid outlet 300 and ascend to the upper portion, and the microfluid rotating while remaining for a certain time in the trap body 100 is descended by the gravitational force, and then, may be discharged through the channel of the microfluid outlet 300.

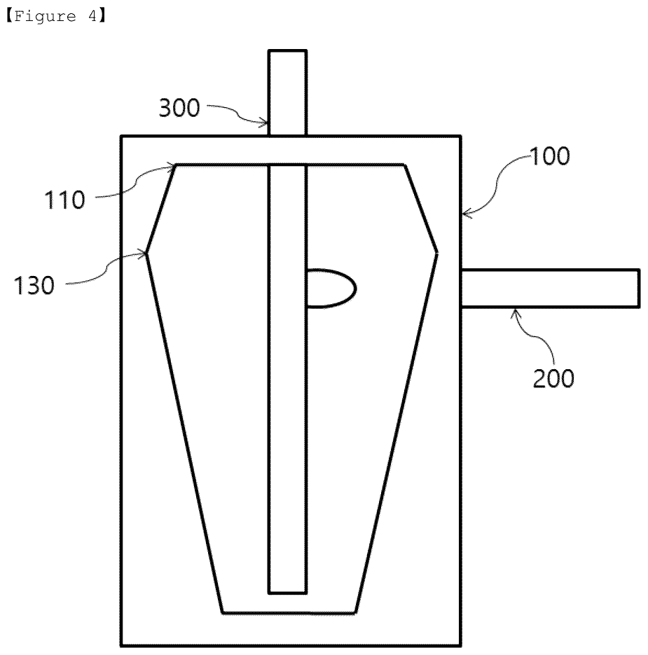

Furthermore, even in the case that the diameter of the lower portion is manufactured to be smaller than the diameter of the upper portion, the portion at which the side surface of the inside and the inner surface of the upper portion meet forms the edge 110, and the bubble simultaneously introduced with the microfluid may be preferably collected at the upper portion. That is, the upper edge formed by the inside of the upper portion of the trap body and the side surface inner wall of the trap body may have the edge 110 shape which is connected along the circumference of the side surface inner wall, and the upper edge 110 formed by the inside of the upper portion of the trap body and the side surface inner wall of the trap body preferably has an angle of 70° to 120° based on the inner side surface of the upper portion. If the angle formed by the upper edge is less than 70°, as the capacity of the inside of the trap body is decreased, the remaining time of the microfluid in the trap body is reduced, and accordingly, the separation may not be perfectly performed. If the angle exceeds 120°, to form the cyclone shape, since a portion to be bent once more needs to be formed inside the trap body, which is difficult to manufacture, the cost may be increased (see FIG. 4).

In describing the operation scheme of the bubble trap having the cyclone shape in more detail, firstly, a buffer solution may be supplied to the bubble trap. In this case, the buffer solution may be supplied with a predetermined pressure from the upper portion of the cyclone shape, and the buffer solution fills the inside of the trap body 100 of the bubble trap along the wall surface and is descending. While the buffer solution is descending, when the microfluid outlet 300 is shut down, the buffer solution may be full in the body. When the buffer solution is full in the trap body, the microfluid outlet 300 is open, and the microfluid outlet 300 may also be full of the buffer solution. As described above, after the injection of the buffer solution is completed, the microfluid is supplied through the microfluid inlet 200. In this case, the microfluid may rotate while being supplied in the tangential direction in the trap body 100, the bubble and the microfluid are separated by the centrifugal force, and the fluid descends and the bubble ascends. In this case, since the bubble is not discharged outside and located in the trap body 100, an injection of the microfluid of a desired amount is available without additional injection according to the separation of the bubble.

In addition to the ease separation of the bubble by changing the shape of the inside of the body, the cohesion and the separation of the bubble may be accelerated by forming a specific shape on the surface of the channel.

For this, according to the present disclosure, a microfluidic bubble trap includes a trap body through which the microfluid is injected and separating bubbles; a microfluid inlet connected the trap body in a side direction and supplying the microfluid; and a microfluid outlet installed passing through an upper portion of the trap body, and having a channel, an end of which is disposed at a lower portion of the microfluid inlet wherein the channel of the microfluid outlet is formed with a micro structure.

In this case, the trap body 100 has a cylindrical shape inside portion as described above or a cyclone shape in which the diameter of the upper portion is greater than the diameter of the lower portion. In addition, according to a shape of the trap body portion, the microfluid inlet may be manufactured in the shape as described above and used.

However, the microfluid outlet may include a micro structure 310 formed on a surface of the channel. The bubble which is generally included in the mircrofluid may be removed to the upper portion easily through the trap body structure and the microfluid inlet structure. However, since the fine bubble 500 included in the microfluid has a small size (˜50 μm), the fine bubble 500 is not separated through a boundary layer that forms an interface but remaining in a laminar flow, which is a flow of the microfluid, and the separation may be difficult. However, the specific gravity of the fine bubble may be smaller than that of the microfluid, the find bubble may be located at the center of the trap body owing to the trap body structure, and in this case, since the microfluid outlet is located at the center of the body, the fine bubble may be easily removed when forming a structure that enables to separate the fine bubble in the microfluid outlet.

The micro structure 310 may be formed on the surface of the channel of the microfluid outlet. The micro structure is a portion of capturing the fine bubble included in the microfluid and may have an optimal size and shape to attach the fine bubble.

For this, the micro structure may be formed with a cylindrical shape, a triangular prism shape, a pentagonal column shape, a hexagonal column shape, or an octagonal column shape of 50-100 μm height and 50-100 μm diameter, and a spacing between the micro structures may be 50 to 200 μm.

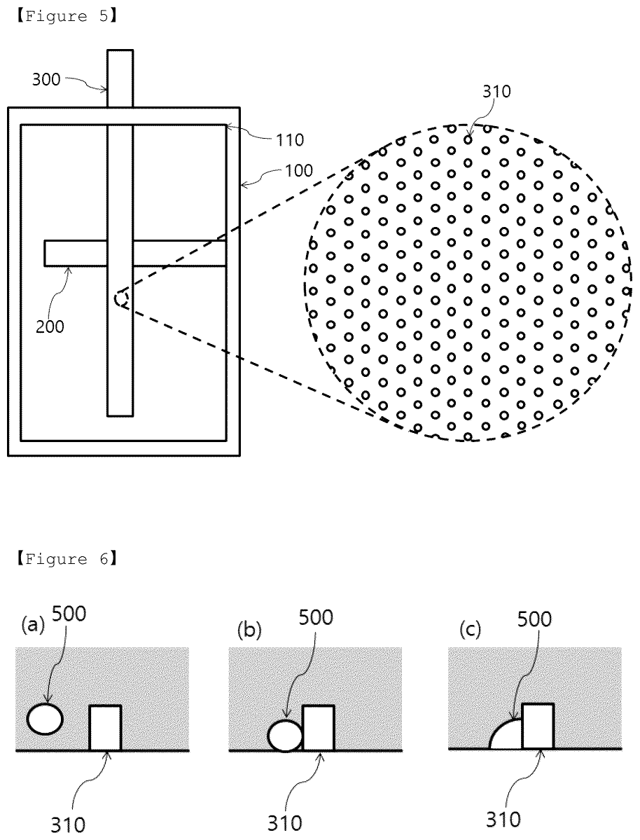

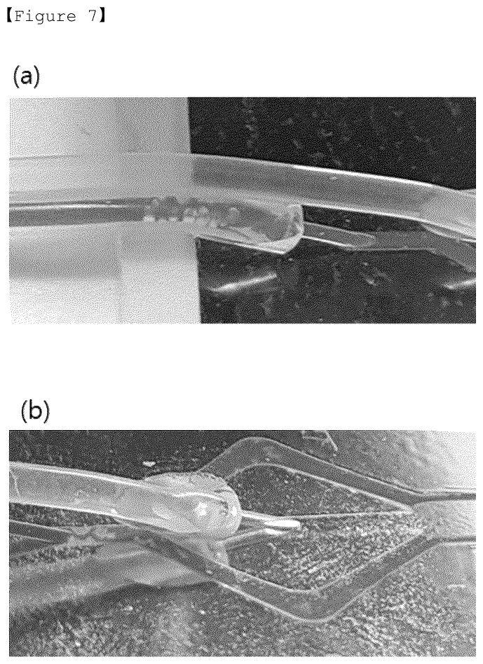

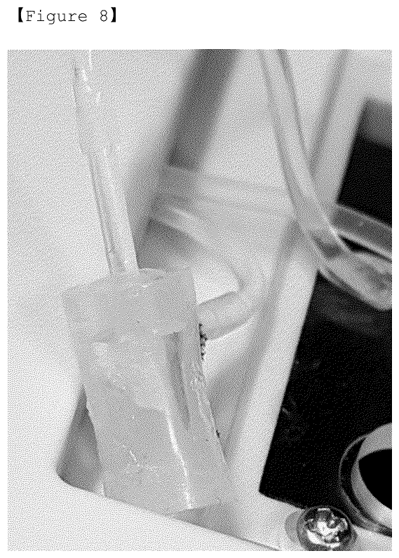

The micro structure may be a protrusion of a cylindrical shape formed on a surface of the channel. In this case, the micro structure may be formed with a plurality of edges to which the bubble may be attached (see FIG. 5). Generally, even in the case that the micro structure has the edge structure, an attachment of the bubble to the edge structure an attachment to the structure is not easy. However, according to the present disclosure, a plurality of micro structures 310 is formed, stochastically, the probability of the attachment of the fine bubble 500 becomes greater.

The micro structure 310 may have a size greater than a size of the fine bubble such that the attachment of the fine bubble 500 becomes easy. In the case of a general fine bubble 500, the size is 50 μm or smaller, and thus the micro structure 310 may be formed with a cylindrical shape of a height 50 to 100 μm and a diameter 50 to 100 μm. If a height of the micro structure 310 is less than 50 μm or a diameter of the micro structure 310 is less than 50 μm, a surface tension is formed by the micro structure 310, and it may be difficult to attach the fine bubble 500. If a height of the micro structure 310 exceeds 100 μm or a diameter of the micro structure 310 exceeds 100 μm, due to the big size, it may be difficult to attach or remove the fine bubble 500 since the number of micro structures 310 is decreased. In addition, the size of the micro structure 310 becomes greater, since the bubble of a size that exceeds the size of the fine bubble is easily attached, it may be difficult to attach the fine bubble 500.

Furthermore, a spacing between the micro structures 310 may be 50 to 200 μm. If the spacing between the micro structures 310 is less than 50 μm, the fine bubble 500 may not be attached to the lower portion of the micro structure, and the removal of the fine bubble 500 may be difficult. If the spacing between the micro structures 310 exceeds 200 μm, the bubble of big size may be attached, and simultaneously, the number of micro structures 310 may be decreased, and the removal efficiency of the fine bubble may be degraded.

To improve the effect of the micro structure 310 further, the micro structure 310 may have the hydrophile property when the microfluid has the hydrophobic property, and may have the hydrophobic property when the microfluid has the hydrophile property. That is, the microfluid and the micro structure 310 may have opposite properties. Through this, the attachment of the fine bubble 500 may become easier than the microfluid to the micro structure.

The fine bubble attached to the micro structure as described above is merged with a neighboring fine bubble and becomes greater in size, and the fine bubble of the greater size may move to the upper portion along the surface of the channel. In this case, as described above, the upper edge formed between the inner side of the upper portion of the trap body and the side surface inner wall of the trap body has the edge shape which is connected along the circumference of the side surface inner wall such that the fine bubble moved to the upper portion is located at the upper portion of the body, and the upper edge formed between the inner side of the upper portion of the trap body and the side surface inner wall of the trap body may have an angle of 70 to 120° based on the inner side surface of the upper portion.

Furthermore, to prevent descending of the bubble, the stepped portion may be formed, as described above.

The present invention provides a microfluidic based diagnostic system including the microfluidic bubble strap.

The microfluidic based diagnostic system may include a fluid supplying portion for supplying a buffer solution or a microfluid; a microfluidic bubble trap for removing bubbles included in the fluid supplied from the fluid supplying portion; a lab-on-a-chip for mixing and separating the fluid passing through the microfluidic bubble trap; and a diagnosing means for analyzing the microfluid passing through the lab-on-a-chip.

The fluid supplying portion 1000 may include a pump for supplying the microfluid and a tube and valve for transferring the fluid, and may perform stable fluid supply through a proper flow rate control.

The bubble trap 2000 may include a bubble trap body, an inlet, and an outlet, and may confine the fine bubbles inflowed from the fluid supplying portion 1000 in the bubble trap body 100, thereby preventing the fine bubbles from being introduced to the inside of channel of the lab-on-a-chip 3000.

The lab-on-a-chip 3000 may be formed of plastic or plastic with glass (ceramic) and include an inlet through which fluid is introduced, an outlet, a fine channel, and the like to perform separation, measurement, incubation, and analysis.

The diagnosing means 4000 may include an optical system provided with a fluorescence system and a high performance camera, and a sensor for sensing wherein it performs fluorescence analysis, single cell analysis, protein analysis, and the like.

The diagnostic system control device 5000 may include a hardware including a central processing unit (CPU), input/output devices (for example, a flow rate sensor, a pinch valve, and a touch interface, etc.) to control communication and tuning between the input/output devices wherein it performs to analyze the data collected from the diagnosing means 4000.

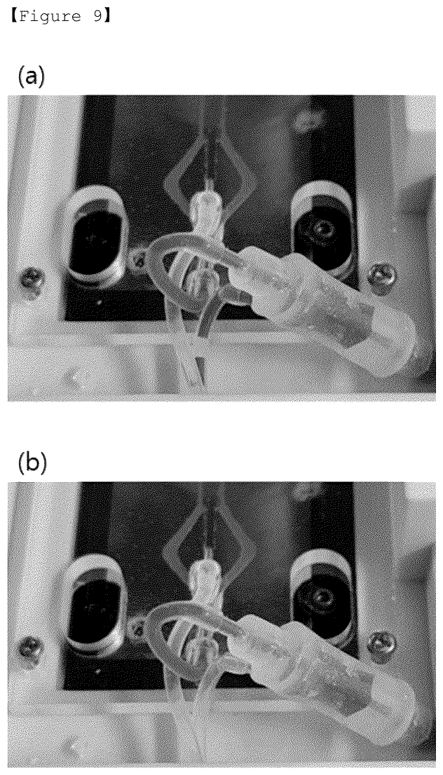

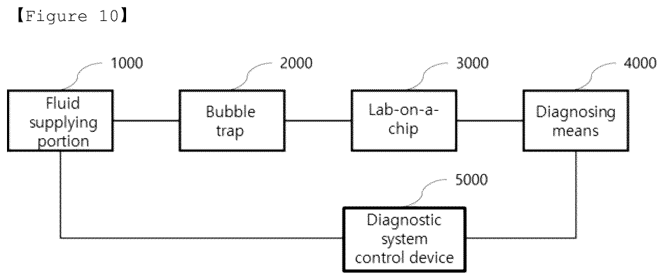

The microfluidic based diagnostic system may include the lab-on-a-chip 3000. As described above, the accuracy of the diagnostic system based on microfluid is significantly dependent on whether bubbles present in the microfluid. Accordingly, in the present invention, bubbles of the fluid are removed by using the microfluidic bubble trap 2000, and the fluid is provided to the lab-on-a-chip 3000, and therefore, the reliability of the diagnostic system may be greatly improved (see FIG. 9 and FIG. 10).

The lab-on-a-chip 3000 may include: a channel portion in which a fluid including a sample containing a magnetic particle and a buffer solution is accommodated and moved therethrough, and having an inlet through which the fluid is introduced and an outlet through which the magnetic particle and the buffer solution separated from the sample are discharged; and a turbulence forming portion for producing a turbulent flow inside the channel that is not in contact with the wire, which is disposed on an outer surface of the channel portion, generates a magnetic gradient to separate the magnetic particle, and includes one or more wires one end of which is parallel with a flow direction of the fluid.

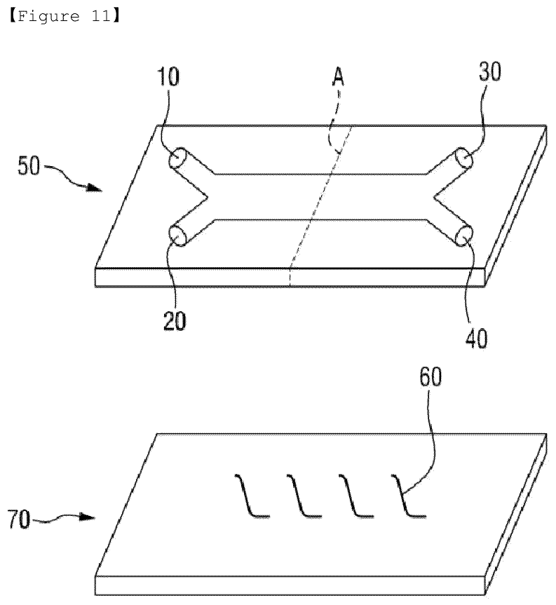

FIG. 11 illustrations a schematic diagram of the lab-on-a-chip 3000 device. As shown in FIG. 11, the lab-on-a-chip 3000 according to the present disclosure includes the channel portion 50 and the magnetic portion 70. The channel portion 50 and the magnetic portion 70 are general elements included in the lab-on-a-chip in the field of using the magnetophoresis separation technique, and the present disclosure is not limited thereto. In addition, the injection, movement and discharge of the sample and the buffer solution may be performed by the turbulence owing to the pressure which is generated by an operation of a syringe pump (not shown).

The channel portion 50 in which a fluid including a sample containing a magnetic particle and a buffer solution is accommodated and moved therethrough, includes an inlet through which the fluid is introduced and an outlet through which the magnetic particle and the buffer solution separated from the sample are discharged. According to the present disclosure, as shown in FIG. 11, it is described as having two inlets and outlets, respectively, but not limited thereto. Particularly, through a first inlet 10 located at a relatively upper side, the sample containing the magnetic particle is introduced, and through a second inlet 20, the buffer solution is introduced. In addition, through a first outlet located at a relatively upper side, the fluid containing the sample and the buffer solution is discharged, and through a second outlet 40, the cell coupled with the magnetic particle is separated from blood and discharged.

In this case, the sample may be blood and includes a target cell and a nontarget cell. The target cell may be a circulating tumor cell (CTC) included in the blood. The nontarget cell may be normal cells such as leukocyte contained in the blood.

The magnetic portion 70 is disposed at an outer surface of the channel portion 50, generates the magnetic gradient to separate the magnetic particle, and includes one or more wires 60 an end portion of which is parallel with a flow direction of the fluid. The magnetic portion 70 provides magnetic force in the chamber such that the magnetic particle introduced to the first inlet 10 moves to the second outlet 40 and is discharged.

In this case, the wire 60 is generally used in the field and not limited specifically. Particularly, a ferromagnetic wire may be used therefor, for example, one or an alloy of two or more selected from a group including nickel, iron, cobalt, and molybdenum.

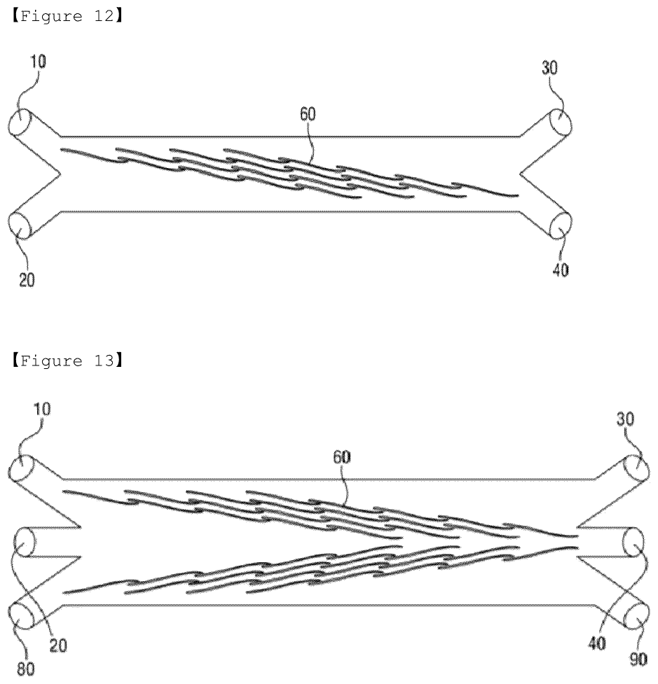

As shown in FIG. 12, an end portion of the wire 60 is parallelly formed with the flow direction of the fluid such that the fluid force has the maximum value, and the magnetic particle is separated and discharged through the second outlet 40 in the magnetic portion 70.

In addition, to separate and discharge efficiently the magnetic particle attached to the channel portion 50 that corresponds to the end portion of the wire 60 located at the magnetic portion 70, as shown in FIG. 12, the turbulence forming portion 80 is disposed at the channel portion 50 not to contact the wire 60. The role of the turbulence forming portion 80 in the lab-on-a-chip according to the present invention may be divided into two cases. One is to distribute easily the blood sample introduced through the inlet, and another is to separate easily the magnetic particle at the end portion of the wire 60 as described above. For this, in the lab-on-a-chip according to the present invention, when the channel portion 50 and the magnetic portion 70 located at the lower end of the channel portion 50 are seen from the upper portion, the turbulence forming portion 80 is located at an area not overlapped with the wire 60 of the magnetic portion 70, and accordingly, the turbulence forming portion 80 is located at the channel, and the wire 60 is located at the magnetic portion 70.

The position of the turbulence forming portion 80 is described in detail with reference to FIG. 13. The turbulence forming portion 80 may be provided at the upper portion and the lower portion based on the center line 90 in the channel portion and in this case it is preferably located between wires 60. The center line 90 in the channel portion bisects the channel portion 50 accurately. Based on the center line 90, the turbulence forming portion 80 located at the upper portion serves to improve the distribution of the blood introduced through the inlet, and the turbulence forming portion 80 located at the lower portion serves to separate the magnetic particle from the end portion of the wire 60 as described above. Accordingly, it is preferable that the turbulence forming portion 80 is formed between the upper end portion or the lower end portion of the wire parallel with the flow direction of the fluid and the center line 90 in the channel portion. More preferably, since it is advantageous to be closer to the upper end portion or the lower end portion of the wire to maximize the influence of the turbulence forming portion 80, the turbulence forming portion 80 may be formed between the point on which the tangential inclination of the wire 60 is abruptly changed and the upper end portion or the lower end portion of the wire parallel with the flow direction of the fluid. More preferably, two or more wires 60 are formed, the turbulence forming portion 80 is formed between one wire 60 and another wire 60, and it is formed between the point on which the tangential inclination of the wire 60 is abruptly changed and the upper end portion or the lower end portion of the wire parallel with the flow direction of the fluid.

The turbulence forming portion 80 is not limited so long as the turbulence forming portion 80 forms a turbulence in the fluid inside of the channel portion 50, and may have a protruding shape or a grooved shape, for example.

In addition, the shape of the protruding shape of the turbulence forming portion 80 may be a rhombus, a circle, an ellipse, a wedge, and a half circle, and in addition, a part or the whole of a polygon including a triangle, a rectangle, a pentagon, and a hexagon, a part or the whole of a circle, a part or the whole of an ellipse. Each of the protrusions is preferable to be identical, but may be different depending on the position.

Furthermore, in the lab-on-a-chip according to the present invention, the end portion of the wire 60 may have a shape of a rectangle, an awl shape, a downward awl shape, an upward awl shape, and a streamlined shape to separate the magnetic particle from the wire 60 easily.

Although the particulars of the present disclosure have been described in detail, it will be obvious to those skilled in the art that such particulars are merely preferred embodiments and are not intended to limit the scope of the present disclosure. Accordingly, the substantial scope of the present disclosure is defined by the appended claims and the equivalence thereof.

1. A microfluidic bubble trap comprising:
a trap body into which a microfluid is introduced and which separates bubbles;
a microfluid inlet connected from a side direction of the trap body and supplying the microfluid; and
a microfluid outlet installed passing through an upper portion of the trap body and having a channel, an end of which is disposed at a lower portion of the microfluid inlet.

2. The microfluidic bubble trap of claim 1, wherein an internal cross section of the trap body is formed in a circular shape, a triangular shape, a rectangular shape, a pentagonal shape, or an octagonal shape.

3. The microfluidic bubble trap of claim 1, wherein an end of a channel of the microfluid inlet is extended to a position that crosses a center of the trap body and disposed therein.

4. A microfluidic bubble trap comprising:
a trap body of which into a cylindrical internal portion the microfluid is introduced and which separate bubbles;
a microfluid inlet connected with the trap body from a side direction thereof and supplying the microfluid; and
a microfluid outlet installed passing through an upper portion of the trap body and having a channel, an end of which is disposed at a lower portion of the microfluid inlet,
wherein an inner diameter of the upper portion of the trap body is greater than an inner diameter of the lower portion thereof.

5. The microfluidic bubble trap of claim 4, wherein the microfluid inlet supplies the microfluid in a tangential direction of the trap body of a cylindrical shape.

6. The microfluidic bubble trap of claim 4, wherein the upper edge formed by an inner side of the upper portion of the trap body and a side surface inner wall of the trap body has an edge shape which is connected along the circumference of the side surface inner wall.

7. The microfluidic bubble trap of claim 6, wherein the upper edge formed by an inner side of the upper portion of the trap body and the side surface inner wall of the trap body has an angle of 70° to 120° based on the inner side surface of the upper portion.

8. A microfluidic bubble trap comprising:
a trap body into which the microfluid is introduced and which separates bubbles;
a microfluid inlet connected from a side direction of the trap body and supplying the microfluid; and
a microfluid outlet installed passing through an upper portion of the trap body, and having a channel, an end of which is disposed at a lower portion of the microfluid inlet,
wherein the channel of the microfluid outlet has a micro structure formed on a surface thereof.

9. The microfluidic bubble trap of claim 8, wherein the micro structure is formed in a cylindrical shape, a triangular prism shape, a rectangular prism shape, a pentagonal column shape, a hexagonal column shape, or an octagonal column shape having a height of 50 μm to 100 μm and a diameter of 50 μm to 100 μm, and an interval between each micro structure is 50 μm to 200 μm.

10. The microfluidic bubble trap of claim 9, wherein the micro structure has hydrophile property when the microfluid has hydrophobic property, or has hydrophobic property when the microfluid has hydrophile property.

11. The microfluidic bubble trap of claim 8, wherein the upper edge formed by the inner side of the upper portion of the trap body and the side surface inner wall of the trap body has an edge shape which is connected along the circumference of the side surface inner wall.

12. The microfluidic bubble trap of claim 11, wherein the upper edge formed by the inside of the upper portion of the trap body and the side surface inner wall of the trap body has an angle of 70° to 120° based on the inner side surface of the upper portion.

13. A microfluidic based diagnostic system comprising the microfluidic bubble trap of claim 1.

14. The microfluidic based diagnostic system of claim 13, comprising:
a fluid supplying portion for supplying a buffer solution or a microfluid;
a microfluidic bubble trap for removing bubbles included in the fluid supplied from the fluid supplying portion;
a lab-on-a-chip for mixing and separating the fluid passing through the microfluidic bubble trap; a diagnosing means for analyzing the microfluid passing through the lab-on-a-chip; and
a diagnostic system control device for controlling the diagnostic system.

15. The microfluidic based diagnostic system of claim 14, wherein the lab-on-a-chip comprises:
a channel portion in which a fluid including a sample containing a magnetic particle and a buffer solution is accommodated and moved therethrough, and having an inlet through which the fluid is introduced and an outlet through which the magnetic particle and the buffer solution separated from the sample are discharged; and
a turbulence forming portion for producing a turbulent flow inside the channel that is not in contact with the wire, which is disposed on an outer surface of the channel portion, generates a magnetic gradient to separate the magnetic particle, and includes one or more wires one end of which is parallel with a flow direction of the fluid.
